(19) United States
(12) Patent Application Publication
(10) Pub. No.: US 2005/0246494 A1
(43) Pub. Date: Nov. 3, 2005

(54) Data storage arrangement and method for storing and transferring data

(76) Inventors: Jose L. Leon JR., Sioux City, IA (US); Michael Trover, Sioux City, IA (US); Tim Artz, Kingsley, IA (US); Frank W. O'Neal IV, McCook Lake, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/837,777

(22) Filed: May 3, 2004

(51) Int. Cl. G06F 12/00

(52) U.S. Cl. 711/115

(57) ABSTRACT

A data storage arrangement includes a storage device including a program storage for storing a predetermined operation program, a controller for controlling operation of the storage device based on the operation program, and a memory, and a power source adapted to drive the controller according to the operation program to transfer data stored in the memory to another memory in another storage device connectable to and disconnectable from the storage device.

### BACKGROUND AND SUMMARY

The present invention relates to data storage arrangements and methods for storing and transferring data.

Portable data storage devices come in many forms, ranging from more primitive systems such as punch cards and magnetic tape to more modem systems such as magnetic disk storage, optical storage, and solid-state storage such as flash memory devices. Flash memory devices are becoming increasingly popular as a means for saving large amounts of data on relatively small, highly portable devices. A variety of forms of flash memory are known, such as solid-state floppy-disk card (SSFDC) devices such as the SmartMedia card developed by Toshiba, and the CompactFlash cards developed by Sandisk.

Portable storage devices with flash memory employing the Universal Serial Bus (USB) standard are increasingly popular particularly because of the ease with which they can be used. Typical USB flash drive devices have male USB connectors that are received in a female USB connector of a host computer. As described in, for example, U.S. Patent Application Publication No. US 2003/0167376 A1, published on Sep. 4, 2003, which is incorporated by reference, when a USB flash drive device is connected to a USB port of a host computer, the processor of the USB flash drive device initializes the flash memory of the memory according to an operation of a program storage of the device.

The processor also transmits predetermined device descriptor information including a manufacturer ID and product ID to the host computer at the host computer's request for device information to inform the host computer of initialization of the operation of the USB flash drive. If the operating system of the host computer confirms that a driver corresponding to the manufacturer ID and product ID of the USB flash drive is registered, the host computer loads a corresponding client driver according to the operation routine of the operating system and assigns a USB bus address and system resource to the peripheral device. If the driver of the USB flash drive is not registered, the host computer ordinarily displays a request for installation of the client driver through a monitor.

While highly convenient in many respects, in order to read or write data on most portable storage devices, the device must ordinarily be connected to, e.g., a host computer. This can be inconvenient when, for example, it is only desired to transfer information from one portable storage device to another. For example, to copy data stored on one individual's USB flash drive to another individual's USB flash drive, both flash drives must be connected to a host computer. The data may be copied to the host computer from the first USB flash drive and later copied to the second USB flash drive, or the data may be copied directly to the second USB flash drive while the first USB flash drive is also connected to the host computer.

There are many occasions when it is desirable to exchange information when a host computer is not available or inconvenient. For example, at trade shows, there is often a large amount of print information available that is also available in electronic form on the exhibitor's computer. One attending the show may wish to obtain the information but does not want to carry around the print information. The exhibitor may make portable storage devices available for the attendee to take away, but this can be expensive and, if an attendee wishes to obtain information from a number of exhibitors, the attendee will likely end up with a number of different portable storage devices.

It is desirable to provide a method and apparatus that facilitates the exchange of electronically stored information. It is also desirable to provide a method and apparatus for exchanging information on portable storage devices without the need for a host computer.

In accordance with an aspect of the present invention, a data storage arrangement includes a storage device including a program storage for storing a predetermined operation program, a controller for controlling operation of the storage device based on the operation program, and a memory, and a power source adapted to drive the controller in accordance with the operation program to transfer data stored in the memory to another memory in another storage device substantially identical to and connectable to and disconnectable from the storage device.

In accordance with another aspect of the present invention, a data storage arrangement includes a storage device including a program storage for storing a predetermined operation program, a controller for controlling operation of the storage device based on the operation program, and a memory, and a power source adapted to drive the controller to automatically transfer data stored in the memory to another memory in another storage device connectable to and disconnectable from the storage device upon connection of the storage device and the another storage device.

In accordance with another aspect of the present invention, a data transfer device includes a first connector adapted to connect with a first portable storage device having a first memory, a second connector adapted to connect with a second portable storage device having a second memory, a power source, a program storage for storing a predetermined operation program, and a controller for controlling operation of the data transfer device based on the operation program. The controller is adapted to detect when a first portable storage device is connected to the first connector and a second portable storage device is connected to the second connector and, after the controller detects that the first and second portable storage devices are connected to the first and second connectors, the controller is adapted to be operated by the power source according to the operation program to transfer data from one of the first and second memories to the other one of the first and second memories.

In accordance with still another aspect of the present invention, a method of transferring data includes connecting a storage device including a program storage for storing a predetermined operation program, a controller for controlling operation of the storage device based on the operation program, and a memory to another storage device including another memory, and driving the controller according to the operation program to transfer data stored in the memory to the another memory in another storage device.

### BRIEF DESCRIPTION OF THE DRAWINGS

The features and advantages of the present invention are well understood by reading the following detailed description in conjunction with the drawings in which like numerals indicate similar elements and in which:

FIG. 1 is a schematic view of a data storage arrangement according to an embodiment of the present invention; and

FIG. 2 is a schematic view of a data storage arrangement according to another embodiment of the present invention.

### DETAILED DESCRIPTION

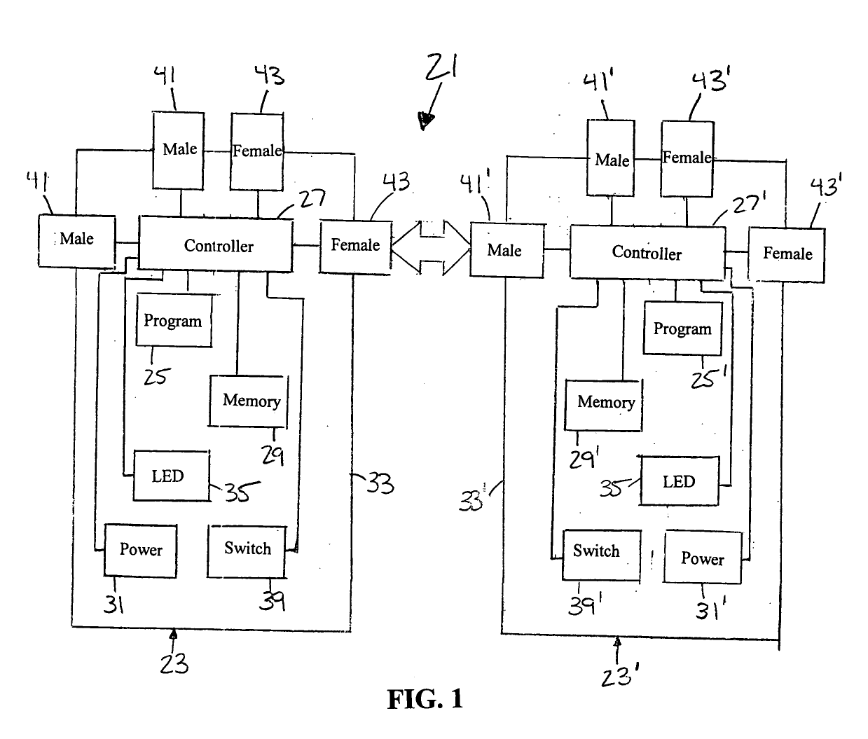

FIG. 1 schematically shows a data storage arrangement 21 according to an embodiment of the present invention. The data storage arrangement 21 preferably includes a storage device 23 including a program storage 25 for storing a predetermined operation program, a controller 27 for controlling operation of the storage device based on the operation program, and a memory 29.

The data storage arrangement 21 further includes a power source 31 adapted to drive the controller 27 to transfer data stored in the memory 29 of a transferring, or host, storage device 23 to another memory 29′ in another, or client, storage device 23′. The power source 31 may be a battery or some other suitable source of power. The client storage device 23′ is preferably identical to or substantially identical to the storage device 23—although, in some embodiments of the invention it may be different—and is connectable to and disconnectable from the storage device 23. The controller 27 preferably automatically transfers data from the host storage device 23 to the client storage device 23′ upon connection of the two devices.

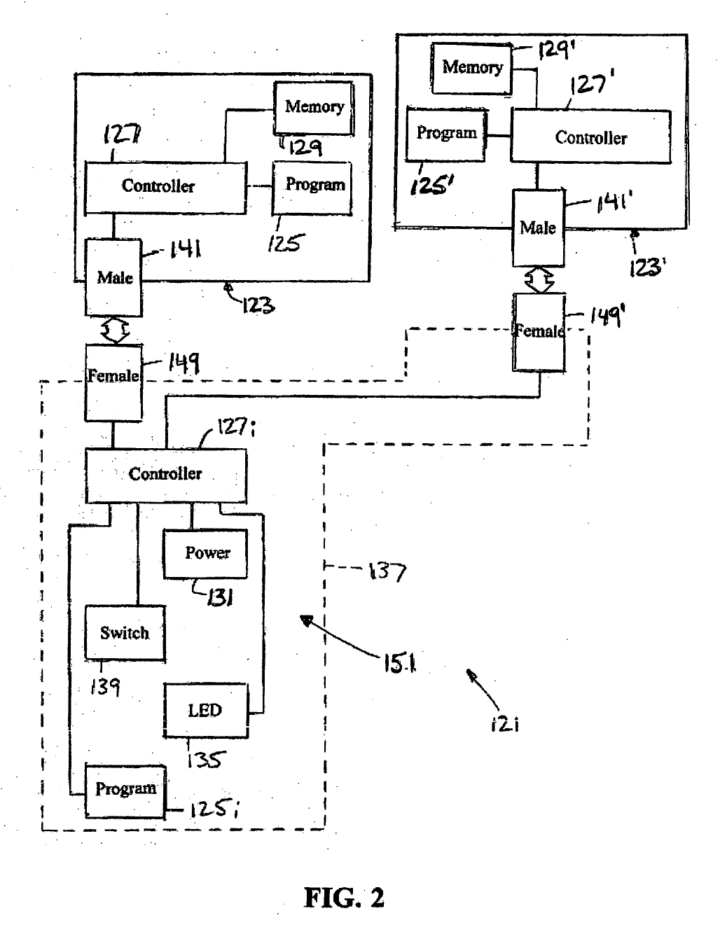

In the embodiment of FIG. 1, the power source 31 is an integral part of the storage device, preferably a replaceable battery, disposed in a body 33 of the storage device. In the embodiment shown in FIG. 1, the data storage arrangement 21 includes a USB flash drive device. Though the present invention is believed to be particularly well-suited for use in connection with USB flash drive devices, it will be appreciated that the present invention is not limited to USB flash drive devices and is suited for use in connection with most forms of magnetic, optical, and solid state memory devices. For example, in the storage arrangement 121 shown in FIG. 2, the power source 131 and the body of the storage device 123 are discrete, connectable and disconnectable components.

As seen in the data storage arrangement 21 of FIG. 1, an indicator 35 is preferably provided to indicate that data stored in the memory has been transferred to the another memory. One of the various suitable types of indicators 33 is an LED, although other indicators may also be used. In the embodiment shown in FIG. 1, the indicator 35 is an integral part of the storage device mounted on the storage device body 33. However, as seen in FIG. 2, an indicator 135 may instead (or in addition) be disposed on a structure other than the storage device body, such as on the body 137 of a structure in which a separate power source 131 is disposed.

As seen in the data storage arrangement 21 of FIG. 1, a switch 39 movable between a first position and a second position may be provided on the body 33 of the storage device as an integral part of the storage device. The switch 39 may be adapted to send a signal to the controller 27 of the storage device 23 identifying the storage device as a storage device from which data is to be transferred when the switch is in the first position and identifying the storage device as a storage device to which data is to be transferred when the switch is in the second position. A program in the program storage 25 may be set up to ensure that certain files stored in the transferring storage device 23 are instantly transferred to the client storage device 23′, such as the files in a folder entitled “Shared”. Another folder may be designated to store all data files that have been transferred to a storage device.

The switch 39 may perform other functions. For example, the switch may send a signal that causes copied files to be appended to files already stored in the client storage device 23′ when the switch is in a first position and that causes copied files to overwrite files stored in the client storage device when the switch is in the second position. Multiple switches may be provided to perform various different functions. For example, a first switch could identify a storage device as a host or client storage device while a second switch could control whether data is appended to or written over data already stored in the device. Additionally, a single switch may be movable between more than two positions to perform a variety of functions. As seen in FIG. 2, a switch 139 or plural switches may instead (or also) be disposed on structure other than the storage device body that is discrete with respect to and connectable to and disconnectable from the storage device, such as the body 137 of the structure in which the separate power source 131 is disposed.

In the embodiment seen in FIG. 1, the client storage device 23′ is directly connectable to and disconnectable from the host storage device 23. In this embodiment, both the host and client storage devices 23 and 23′ are USB devices having a male USB connector 41 and 41′. At least the host storage device 23 includes a female USB connector 43, which may be an A-type connector or a B-type connector as required. If desired, of course, both A-type and B-type connectors, male or female or both, may be provided on a single storage device. A second male connector 41 and a second female connector 43 are shown in phantom in FIG. 1.

In the embodiment wherein both the host and client storage device 23 and 23′ are USB devices, the male connector 41′ of the client storage device is preferably inserted directly into the female connector 43 of the host storage device. If the client storage device 23′ also has a female connector, other storage devices can be connected to the client storage device, as well. For example, where host and client storage devices are all identical, two or more storage devices can be connected in a “daisy chain” arrangement. A single host storage device 23 can, in such an arrangement, transfer data to a plurality of connected client storage devices 23′.

Though the present invention is described here primarily in terms of USB flash drive devices, it will be appreciated that, even with such devices used as host storage devices, a client storage device may be any suitable data storage device, such as a magnetic or optical disk, although different structures for writing data, e.g., magnetic heads or laser writing heads and associated hardware and software, to such storage devices than are necessary to write data to flash memory must be provided. Moreover, the host storage device 23 is not limited to USB flash drive devices and, if desired, other forms of memory can be used, such as magnetic or optical disks, although this would require that structures for reading data from such media, e.g., magnetic heads and detectors, must also be provided.

The operation program in the program storage 25 can include a device recognition processing block that permits the controller 27 to identify whether the storage device 23 is connected to a client storage device 23′, to a computer, to a peripheral device, or to some other structure. In addition to facilitating the transfer of data between portable storage devices, if the male connector 41 of a USB storage device 23 is disposed in the female connector (not shown) of a computer, the storage device 23 can permit other USB based peripheral devices to be connected to the computer without closing off access to a USB port.

FIG. 2 shows an embodiment of a storage device 123 wherein the power source 131 and the controller 127 operate according to a program in program storage 125 to transfer data stored in the memory 129 to the another memory 129′ in a client storage device 123′ when a male connector 141 of the storage device 123 and a male connector 141′ of the client storage device 123′ are received in female connectors 149 of an intermediate component 151. In this embodiment, the power source 131 can be disposed in a body 137 (shown in phantom) of the intermediate component 151 although the intermediate component need not have all of its components disposed in a single body. The controller 127 and the program storage 125 can be in the storage devices 123 and 123′ as is typically the case with USB flash drive devices, or partially in an intermediate component 151 and partially in the storage devices, or entirely in an intermediate component. The controller 127 can be dedicated to transferring data between two or more portable storage devices connected to the intermediate component although the controller may perform additional desired functions. The intermediate component 151 can be a dedicated device that only functions to transfer data between attached storage devices and need not include memory of the type provided in the storage devices 123 and 123′.

The storage devices 123 and 123′ may include male and female connections to facilitate connection to the intermediate component 151 or other structures. For example, one or both of the storage devices 123 and 123′ may be USB flash drives with male USB connections for mating with female ports on the intermediate component or female ports for mating with male connections on other USB flash drive devices or computer peripheral devices. The intermediate component 151 may be adapted to connect more storage devices than the two storage devices 123 and 123′ shown by providing additional connection ports. One or both of the storage devices 123 and 123′ may include program storage 125 and 125′ and the intermediate component 151 may also include program storage 125i. If desired, the intermediate component 151 may include program storage 125i while the storage devices have no program storage.

A controller is preferably adapted to detect when a storage device 123 is connected to a first connector 149 and a second portable storage device 123′ is connected to a second connector 149′. Preferably, when the controller detects that the first and second portable storage devices 123 and 123′ are connected to the first and second connectors 149 and 149′, the power source 131 powers the controller to transfer data from one of the first and second portable storage devices to the other one of the first and second portable storage devices. The controller may be a controller 127 on the storage device 123 and may, for example, request device identification information from a controller 127′ on the storage devices 123′. The controller may, alternatively or additionally, be a controller 127′ that is part of the intermediate device 151 and may request device identification information from the storage devices 123 and 123′, such as from separate controllers 127 and 127′ on the devices.

The intermediate device 151 may also include one or more switches 139 and one or more indicators 135. Some or all of the storage devices 123 and 123′ may also have switches and indicators. Switches on the intermediate device 151 and switches on the storage devices 123 and 123′ may be arranged to cooperate with one another to achieve different results, such as to transfer data from one of the storage devices to the other and to append or overwrite the data on the memory of the client storage device.

Operation of an embodiment of the present invention is described in connection with the embodiment of FIG. 1, except as otherwise noted. The data storage arrangement 21 includes a storage device 23 including a memory 29 that is connected to another storage device 23′ with another memory 29′. The data storage arrangement 21 includes program storage 25 for storing a predetermined operation program, a controller 27 for controlling operation of the storage device based on the operation program, and a power source 31. The controller 27 is driven by the power source 31 to transfer data stored in the memory 29 to the memory 29′ in client storage device 23′.

The program storage 25, the controller 27, and the power source 31 can be integral parts of a single body 33 of the storage device 23 as seen in FIG. 1. In other embodiments, however, one or more of the program storage, the controller, and the power source can be part of an intermediate device. For example, in the embodiment of FIG. 2, the power source 131 is part of an intermediate device 151 while the program storage 125 and the controller 127 are part of the storage device 123. The storage devices 23′ and 123′ of FIGS. 1 and 2, respectively, can be identical to the storage devices 23 and 123, respectively, or different.

In the embodiment of FIG. 1, the client storage device 23′ is directly connected to the host storage device 23. The host storage device 23 is provided with a female connector 43 to receive a male connector 41′ of the client storage device 23′. In an embodiment of the invention, upon connection of the host and client storage devices 23 and 23′, a signal is sent to the controller 27. The controller 27 recognizes the client storage device 23′ as the client storage device and automatically transfers data from a folder on the host device to a folder on the client device.

While the present invention is considered to be particularly well-suited for transferring data between two substantially similar USB flash drive devices, the present invention is considered to be highly useful for other types of portable storage devices. For example, data can be transferred from any type of storage device, such as a magnetic or optical disk or a flash memory, to the same or a different type of storage device.

While certain flash memory storage devices typically include a controller and program storage together with the storage device, other types of storage devices only have memory. It will be appreciated that it is consistent with aspects of the present invention that the memory and the controller and program storage and the power source can be on different components. Of course, providing the memory, controller, program storage, and power source on a single device, such as a USB flash memory device, may be desirable from the standpoint of convenience.

The applications for the present invention are substantially limitless. For example, users may find the present invention useful for exchanging business data, such as at conferences where it is not convenient to have a personal computer, or other types of data, such as multimedia files such as MP3 files.

While this invention has been illustrated and described in accordance with a preferred embodiment, it is recognized that variations and changes may be made therein without departing from the invention as set forth in the claims.

1. A data storage arrangement, comprising:
a storage device including a program storage for storing a predetermined operation program, a controller for controlling operation of the storage device based on the operation program, and a memory; and
a power source adapted to drive the controller in accordance with the operation program to transfer data stored in the memory to another memory in another storage device substantially identical to and connectable to and disconnectable from the storage device.

2. The storage arrangement as set forth in claim 1, wherein the power source is an integral part of the storage device.

3. The storage arrangement as set forth in claim 1, wherein the power source and the storage device are discrete, connectable and disconnectable components.

4. The storage arrangement as set forth in claim 1, further comprising an indicator to indicate that data stored in the memory has been transferred to the second memory.

5. The storage arrangement as set forth in claim 4, wherein the indicator is an LED.

6. The storage arrangement as set forth in claim 4, wherein the indicator is an integral part of the storage device.

7. The storage arrangement as set forth in claim 1, further comprising a switch movable between a first position and a second position, the controller of the storage device identifying the storage device as a storage device from which data is to be transferred when the switch is in the first position and identifying the storage device as a storage device to which data is to be transferred when the switch is in the second position.

8. The storage arrangement as set forth in claim 7, wherein the switch is an integral part of the storage device.

9. The storage arrangement as set forth in claim 7, wherein the switch is on a component that is discrete with respect to and connectable to and disconnectable from the storage device.

10. The storage arrangement as set forth in claim 1, wherein the another storage device is directly connectable to and disconnectable from the storage device.

11. The storage arrangement as set forth in claim 1, wherein the another storage device is connectable to and disconnectable from the storage device through an intermediate component.

12. The storage arrangement as set forth in claim 1, wherein the storage device is a USB device having a male USB connector.

13. The storage arrangement as set forth in claim 12, wherein the storage device includes a female USB connector.

14. The storage arrangement as set forth in claim 13, wherein the storage device includes a female A-type USB connector.

15. The storage arrangement as set forth in claim 13, wherein the storage device includes a female B-type USB connector.

16. The storage arrangement as set forth in claim 13, wherein the power source and the controller are arranged to transfer data stored in the memory to the another memory in the another storage device when a male USB connector of the another storage device is received in the female USB connector of the storage device.

17. The storage arrangement as set forth in claim 13, wherein the storage device includes a female B-type USB connector.

18. The storage arrangement as set forth in claim 12, wherein the power source and the controller are arranged to transfer data stored in the memory to the another memory in the another storage device when the male USB connector of the storage device and a male USB connector of the another storage device are received in female USB connectors of an intermediate component.

19. The storage arrangement as set forth in claim 12, wherein the operation program includes a device recognition processing block that permits the controller to identify whether the storage device is connected to the another storage device.

20. The storage arrangement as set forth in claim 1, wherein the memory is a flash memory.

21. The storage arrangement as set forth in claim 1, wherein at least one of the program storage, the controller, and the memory is removable from the storage device.

22. A data storage arrangement, comprising:
a storage device including a program storage for storing a predetermined operation program, a controller for controlling operation of the storage device based on the operation program, and a memory; and
a power source adapted to drive the controller to automatically transfer data stored in the memory to another memory in another storage device connectable to and disconnectable from the storage device upon connection of the storage device and the another storage device.

23. The storage arrangement as set forth in claim 22, wherein the power source is an integral part of the storage device.

24. The storage arrangement as set forth in claim 22, wherein the power source and the storage device are discrete, connectable and disconnectable components.

25. A data transfer device, comprising:
a first connector adapted to connect with a first portable storage device having a first memory;
a second connector adapted to connect with a second portable storage device having a second memory;
a power source;
a program storage for storing a predetermined operation program;
a controller for controlling operation of the data transfer device based on the operation program,
wherein the controller is adapted to detect when a first portable storage device is connected to the first connector and a second portable storage device is connected to the second connector and, after the controller detects that the first and second portable storage devices are connected to the first and second connectors, the controller is adapted to be operated by the power source according to the operation program to transfer data from one of the first and second memories to the other one of the first and second memories.

26. The data transfer device as set forth in claim 25, further comprising a switch movable between a first position and a second position, the controller identifying a storage device as a storage device from which data is to be transferred when the switch is in the first position and identifying the storage device as a storage device to which data is to be transferred when the switch is in the second position.

27. The data transfer device as set forth in claim 25, further comprising an indicator to indicate that data stored in one portable storage device has been transferred to a second portable storage device.

28. A method of transferring data, comprising:
connecting a storage device including a program storage for storing a predetermined operation program, a controller for controlling operation of the storage device based on the operation program, and a memory to another storage device including another memory; and
driving the controller according to the operation program to transfer data stored in the memory to the another memory in another storage device.

29. The method of transferring data of claim 28, wherein the another storage device is identical to the storage device.

30. The method of transferring data of claim 28, wherein the another storage device is directly connected to the storage device.

31. The method of transferring data of claim 30, wherein the storage device and the another storage device each includes at least one male and at least one female A-type USB connector, a male USB connector of one of the storage device and the another storage device mating with a female USB connector of the other one of the storage device and the another storage device.
